(19) United States
(12) Patent Application Publication
(10) Pub. No.: US 2011/0173918 A1
(43) Pub. Date: Jul. 21, 2011

(54) ADJUSTABLE WALL BRACE

(76) Inventor: Lyndon Graham, Kirksville, MO (US)

(21) Appl. No.: 12/689,343

(22) Filed: Jan. 19, 2010

(51) Int. Cl. E04G 21/26; B23P 17/00; E04B 1/38

(52) U.S. Cl. 52/693; 29/897.3; 52/745.21

(57) ABSTRACT

An adjustable wall brace may include: (a) an adjustment portion including a right-hand threaded portion and a left-hand threaded portion; (b) an extension portion including a threaded aperture configured to received at least one of the right-hand threaded portion and the left-hand threaded portion; and (c) a base portion including a threaded aperture configured to received at least one of the right-hand threaded portion and the left-hand threaded portion.

A method for manufacturing an adjustable wall brace may include: (a) disposing an extension member within an extension receiving member; (b) receiving a first threaded portion of a dual-threaded adjustment mechanism within a threaded receiving aperture of at least one of the extension member and the extension receiving member; and (c) receiving a second threaded portion of the dual-threaded adjustment within a second threaded receiving aperture.

### BACKGROUND

One common construction technique relating to the erection of buildings involves first fabricating horizontal panels and then tilting those panels to a vertical orientation for use as the walls of the building. An important advantage of this technique is that the wall panel can often be fabricated much easier when it is horizontal, where heavy structural members can be more easily handled.

### SUMMARY

An adjustable wall brace may include: (a) an adjustment portion including a right-hand threaded portion and a left-hand threaded portion; (b) an extension portion including a threaded aperture configured to received at least one of the right-hand threaded portion and the left-hand threaded portion; and (c) a base portion including a threaded aperture configured to received at least one of the right-hand threaded portion and the left-hand threaded portion.

A method for manufacturing an adjustable wall brace may include: (a) disposing an extension member within an extension receiving member; (b) receiving a first threaded portion of a dual-threaded adjustment mechanism within a threaded receiving aperture of at least one of the extension member and the extension receiving member; and (c) receiving a second threaded portion of the dual-threaded adjustment within a second threaded receiving aperture.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The disclosure will become more fully understood from the following detailed description, taken in conjunction with the accompanying drawings, wherein like reference numerals refer to like elements, in which Figure Reference No:

1 is a perspective view of an adjustable wall brace;

2 is a side view of an adjustable wall brace;

3 is an exploded view of an extension receiving member and wall engaging plate;

4 is a perspective view of an extension member operably coupled to an extension receiving member;

5 is a cross-sectional view of an extension member operably coupled to an extension receiving member;

6 is a perspective view of a wall engaging plate;

7 is a perspective view of a dual-threaded adjustment mechanism and a base portion;

8 is a side view of the operation of a dual-threaded adjustment mechanism;

9 is a perspective view of a wall engaging plate and a concrete form adapter;

10 is a perspective view of a wall engaging plate and a concrete form adapter;

11 is a perspective view of a wall engaging plate and a concrete form adapter.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

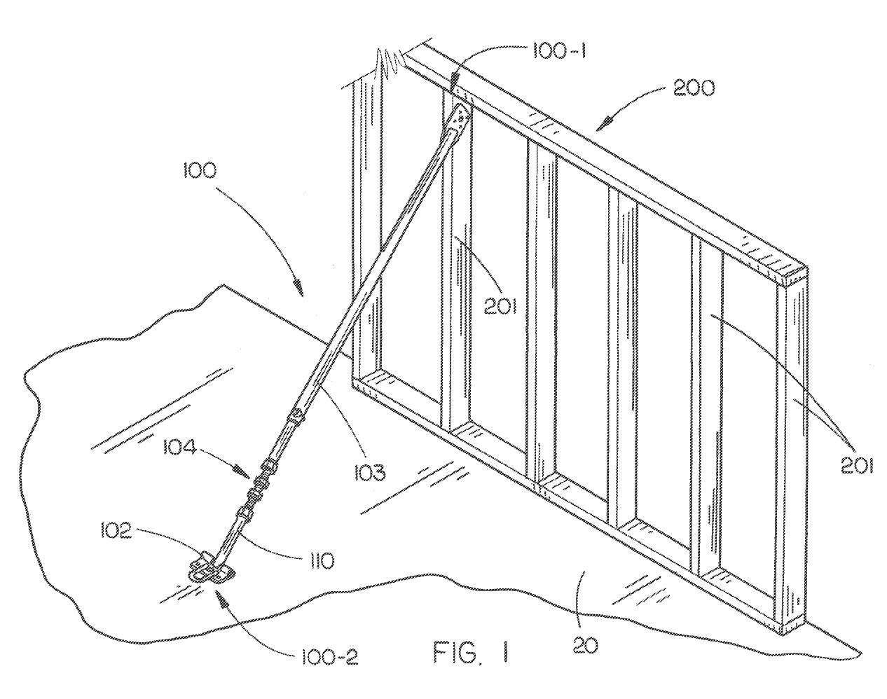

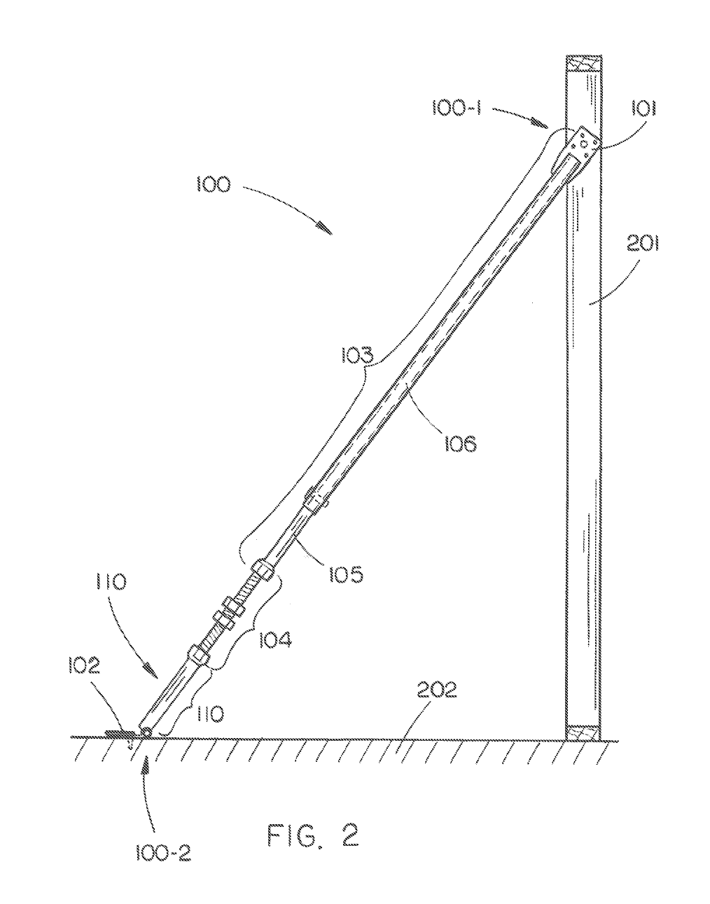

Referring to FIGS. 1 and 2, an adjustable wall brace 100 is shown. A top end 100-1 of the adjustable wall brace 100 may be affixed to a wood-framed wall, a concrete form, and the like (collectively wall 200) by a plate 101 so as to secure the wall 200 in a substantially vertical position. Particularly, the adjustable wall brace 100 may be affixed to a vertical framing member 201 (e.g. a framing stud). A bottom end 100-2 of the adjustable wall brace 100 may be affixed to a floor 202 via a base portion 110 including a footplate 102. The adjustable wall brace 100 may include an extension portion 103 and a dual-threaded adjustment portion 104.

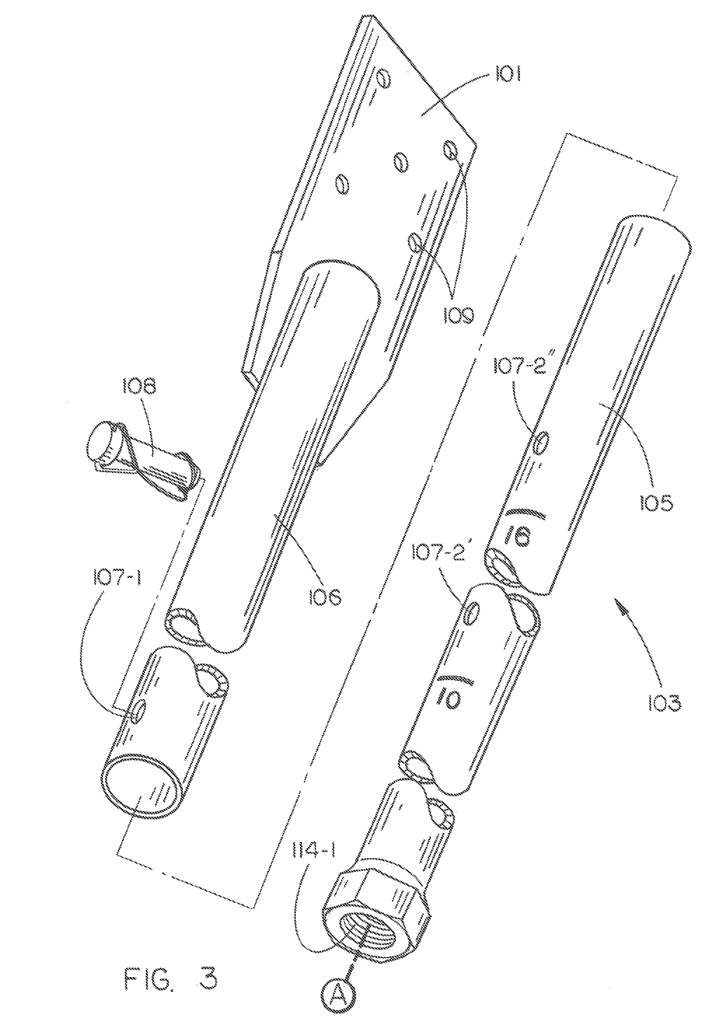

Referring to FIG. 3, the extension portion 103 may include an extendable member 105 and a receiving member 106. The extendable member 105 and the receiving member 106 may be configured such that the inside diameter of the receiving member 106 may be greater than the outside diameter of the extendable member 105 such that the extendable member 105 may be received within the end of the receiving member 106. It will be recognized that the relative diameters of the extendable member 105 and the receiving member 106 may be switched without departing from the spirit of the present invention.

The receiving member 106 may include one or more locking mechanism apertures 107-1. Similarly, the extendable member 105 may include one or more locking mechanism apertures 107-2. When the extendable member 105 is inserted into the receiving member 106, the locking mechanism apertures 107-2 of the extendable member 105 may be co-aligned with the locking mechanism apertures 107-1 of the receiving member 106 so as to receive a locking mechanism 108 through both the locking mechanism apertures 107-1 and the locking mechanism apertures 107-2 so as to operably couple the receiving member 106 and the extendable member 105 and affix the extension portion 103 at a given length.

The extendable member 105 may include two or more locking mechanism apertures 107-2 spaced at particular distances such that the extension portion 103 may be configured at multiple lengths. For example, the extendable member 105 may include two or more locking mechanism apertures 107-2 (e.g. locking mechanism apertures 107-2′ and locking mechanism apertures 107-2″) spaced such that adjustable wall brace 100 may be configured at lengths of 10 feet, 16 feet, and the like when coupled with the receiving member 106 with a locking mechanism 108 via its locking mechanism apertures 107-1.

The locking mechanism 108 may comprise any number of structures which may be disposed within the locking mechanism apertures 107-1 and locking mechanism apertures 107-2 to affix the extension portion 103 at a given length. For example, as shown in FIG. 3, the locking mechanism 108 may include a pin which may be routed through the locking mechanism apertures 107-1 and locking mechanism apertures 107-2 and secured in place with a cotter pin-type device.

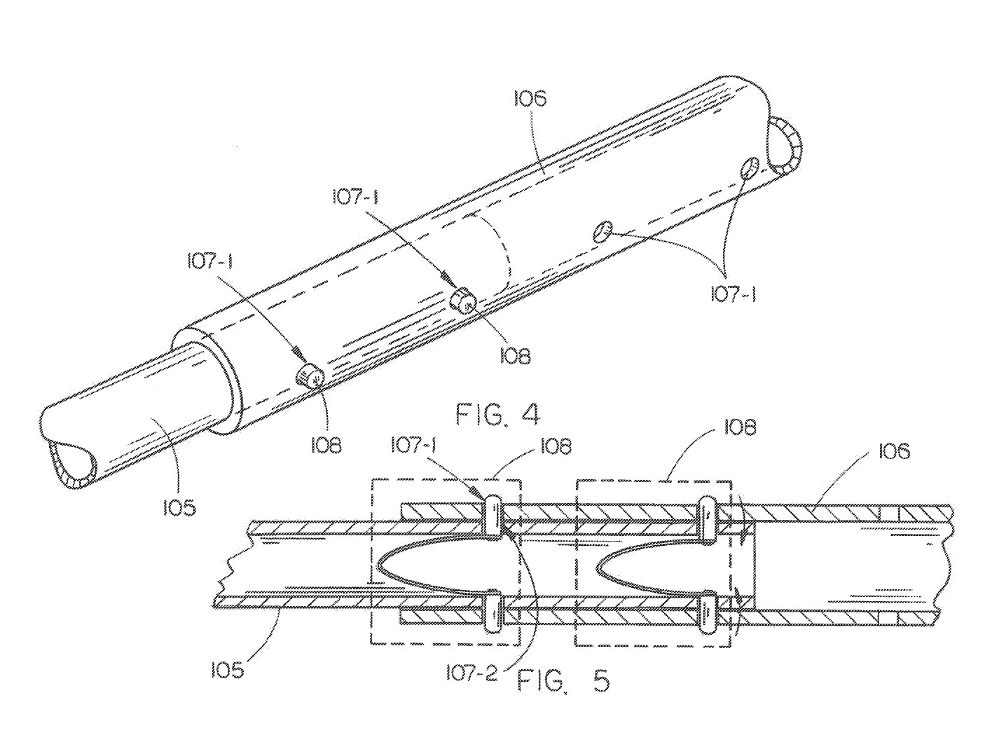

Alternately, referring to FIGS. 4-5, the locking mechanism 108 may include a spring actuated mechanism internal to the receiving member 106 and or the extendable member 105 which includes projections which protrude from the receiving member 106 and/or the extendable member 105 in the absence of an applied force (not shown). For example, the locking mechanism 108 may include one or more button heads coupled to respective terminal ends of a leaf spring. The button heads may protrude from the locking mechanism apertures 107-1 and locking mechanism apertures 107-2 of the receiving member 106 and the extendable member 105 when the locking mechanism 108 is in a locked position. The button heads may be retracted into the interior of the receiving member 106 and the extendable member 105 by the application of force by a user, thereby permitting the adjustment of the relative positions of the receiving member 106 and the extendable member 105.

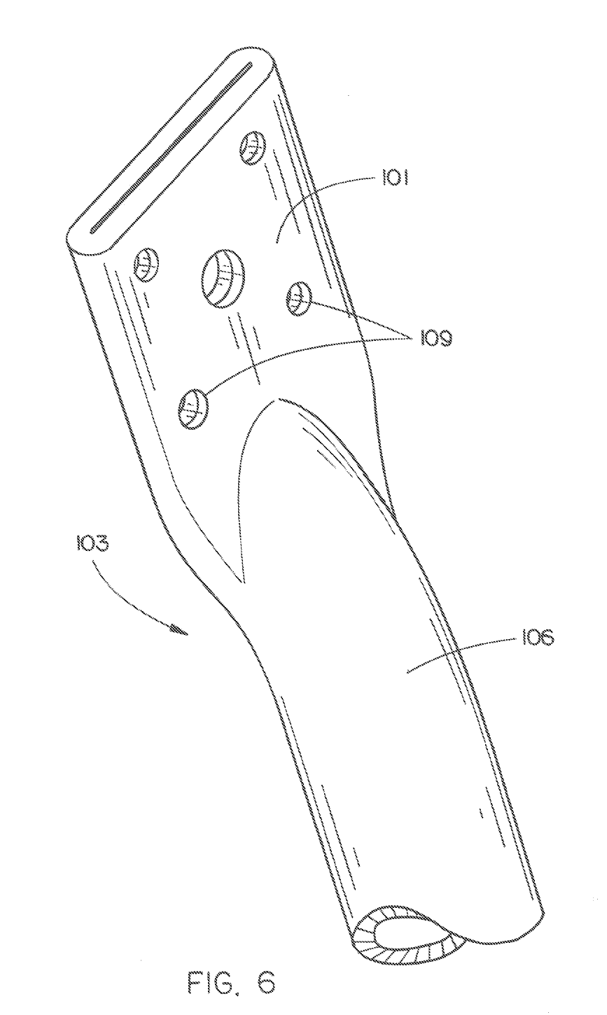

Referring to FIGS. 3 and 6, the receiving member 106 may further include a plate 101. The plate 101 may be affixed to the receiving member 106 such that it may be maintained in a vertical plane when affixed to a framing member 201 of a wall 200. The plate 101 may include one or more fastener apertures 109. The fastener apertures 109 may receive a fastener (e.g. a nail, screw, bolt and the like) which may couple the plate 101 to the wall 200. The plate 101 may be integrally formed with the receiving member 106 as shown in FIG. 6.

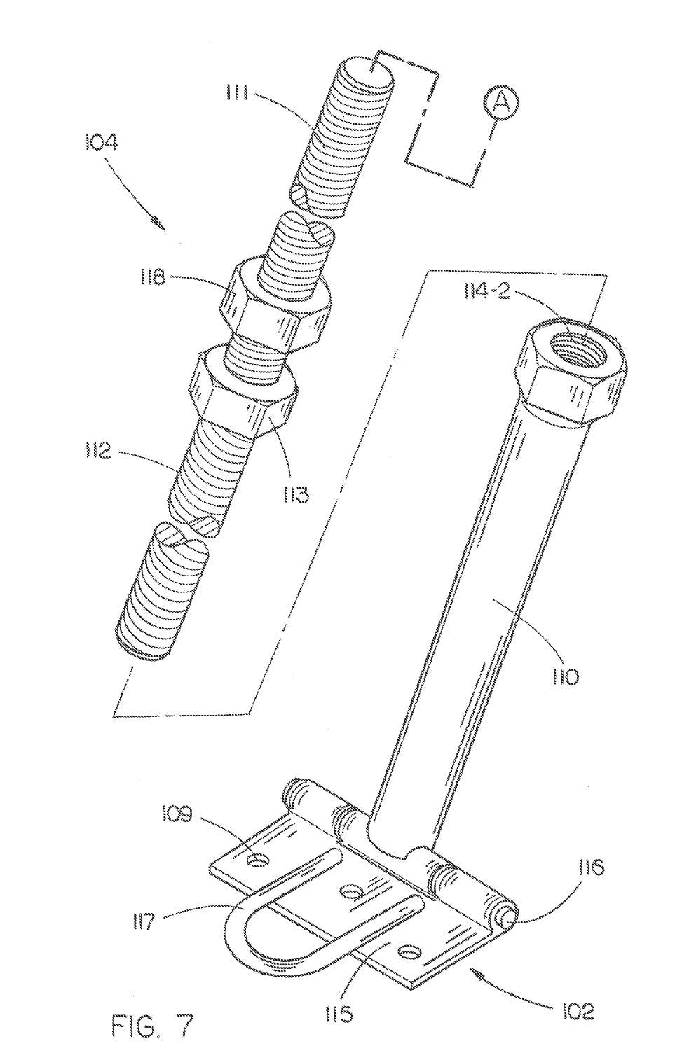

Referring to FIG. 7, the adjustment portion 104 may include a first threaded portion 111 and a second threaded portion 112. The first threaded portion 111 may have a first thread orientation (e.g. a right-handed orientation) while the second threaded portion 112 may have a second thread orientation (e.g. a left-handed orientation). The adjustment portion 104 may further include a torque assist portion 113 (e.g. a hex-nut statically positioned between the first threaded portion 111 and the second threaded portion 112, a torque bar receiving aperture (not shown), and the like).

Referring again to FIG. 3, the extendable member 105 may further include a threaded aperture 114-1 configured to receive the first threaded portion 111 of the adjustment portion 104.

Referring again to FIG. 7, the base portion 110 may similarly include a threaded aperture 114-2 configured to receive the second threaded portion 112 of the adjustment portion 104.

The base portion 110 may further include a footplate 102. The footplate 102 may include one or more fastener apertures 109. The fastener apertures 109 may receive a fastener (e.g. a nail, screw, bolt and the like) which may couple the footplate 102 to the floor 202.

The footplate 102 may include a hinge plate 115 operably coupled a t-connector of the base portion 110 via a hinge pin 116. Such a configuration may allow the base portion 110 to rotate around the axis of the hinge pin 116 during adjustment of the adjustment portion 104 while the hinge plate 115 remains securely anchored to the floor 202.

The footplate 102 may further include a reinforcement member 117. The reinforcement member 117 may serve to enhance the rigidity and durability of the hinge plate 115. Further, the arcuate shape of the reinforcement member 117 may serve to receive an anchor stake 128 in order to anchor the footplate 102 to floor 202 surfaces (e.g. earthen surfaces) which may not be suitable for receiving fasteners (e.g. a nail, screw, bolt and the like) through the smaller fastener apertures 109.

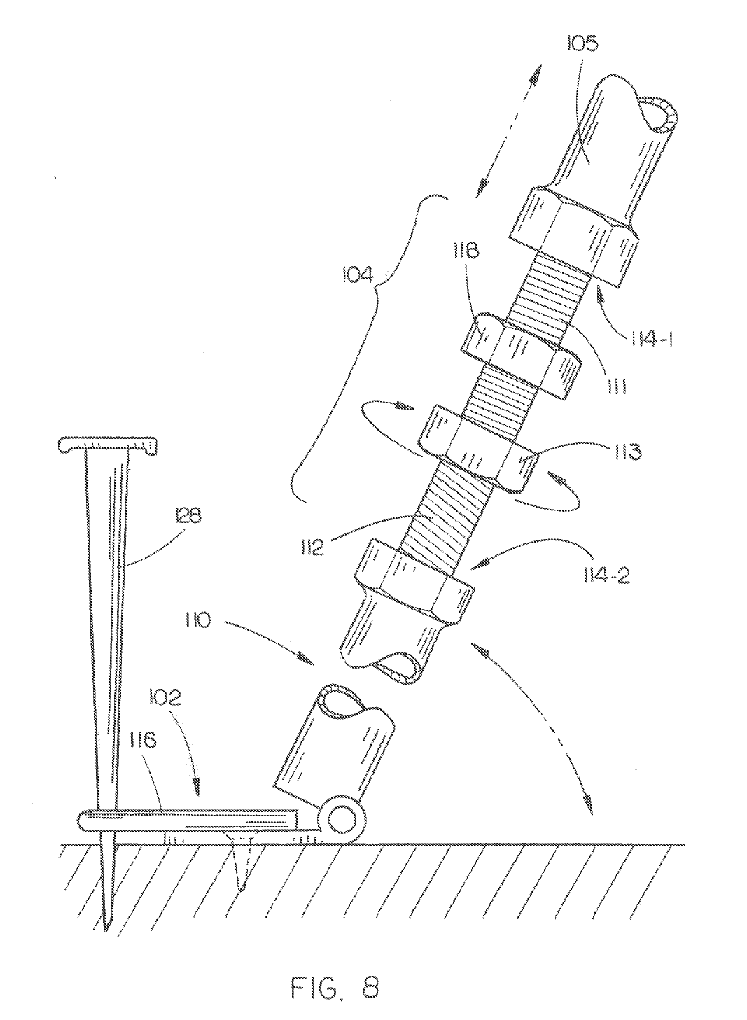

Referring to FIG. 8, the operations of the adjustment portion 104 are shown. As previously described, the threaded aperture 114-1 of the extendable member 105 may receive the first threaded portion 111 of the adjustment portion 104. Similarly, the threaded aperture 114-2 of the base portion 110 may receive the second threaded portion 112 of the adjustment portion 104. Following the insertion of the first threaded portion 111 and the second threaded portion 112, the overall length of the adjustable wall brace 100 may be adjusted by rotating the torque assist portion 113. For example, a clockwise rotation of the torque assist portion 113 may cause the first threaded portion 111 and the second threaded portion 112 to engage the threaded aperture 114-1 and the threaded aperture 114-2, respectively, thereby inserting the first threaded portion 111 and the second threaded portion 112 further into the threaded aperture 114-1 and the threaded aperture 114-2 resulting the overall shortening of the adjustable wall brace 100. Alternately, a counterclockwise rotation of the torque assist portion 113 may cause the first threaded portion 111 and the second threaded portion 112 to disengage the threaded aperture 114-1 and the threaded aperture 114-2, respectively, thereby withdrawing the first threaded portion 111 and the second threaded portion 112 from the threaded aperture 114-1 and the threaded aperture 114-2 resulting in the overall lengthening of the adjustable wall brace 100.

Such a configuration may have the added advantage of allowing for the extension or retraction of the adjustable wall brace 100 while the footplate 102 and the plate 101 remain statically positioned while affixed to the floor 202 and wall 200, respectively.

The adjustment portion 104 may further include a locking nut 118. The locking nut 118 may be rotated about the first threaded portion 111 so as to draw the locking nut 118 substantially adjacent to the extendable member 105 of the extension portion 103 so as to further secure the extension portion 103 in a particular position with respect to the adjustment portion 104. A second locking nut (not shown) may be employed in a similar manner so as to further secure the base portion 110 in a particular position with respect to the adjustment portion 104.

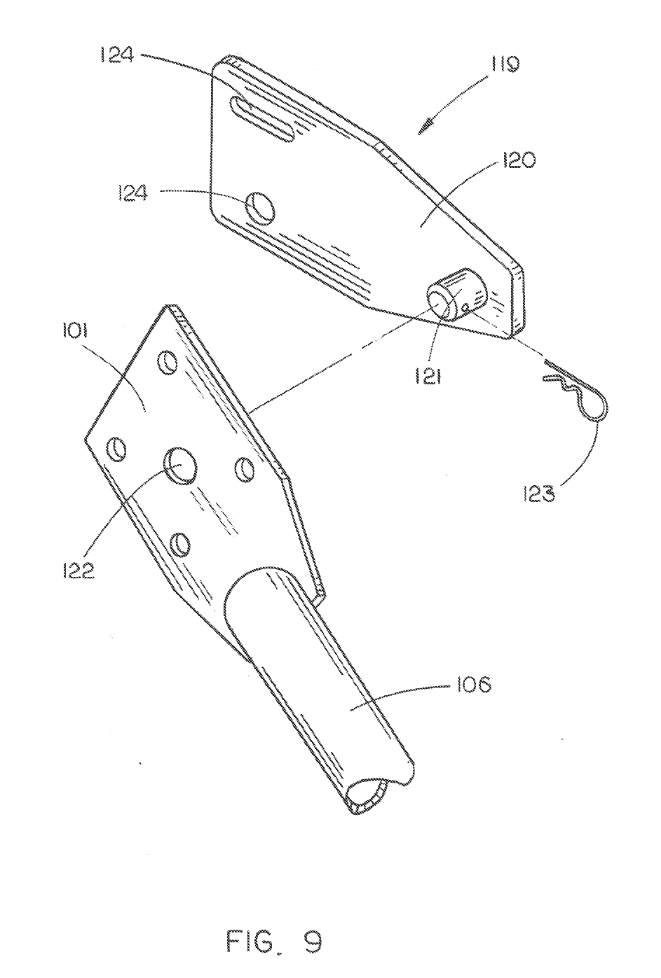

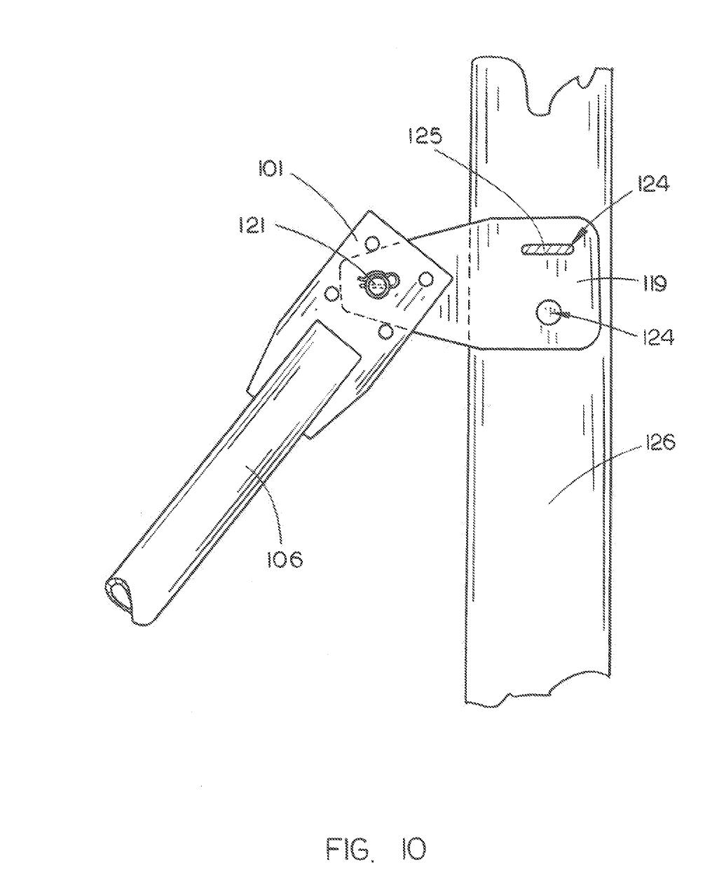

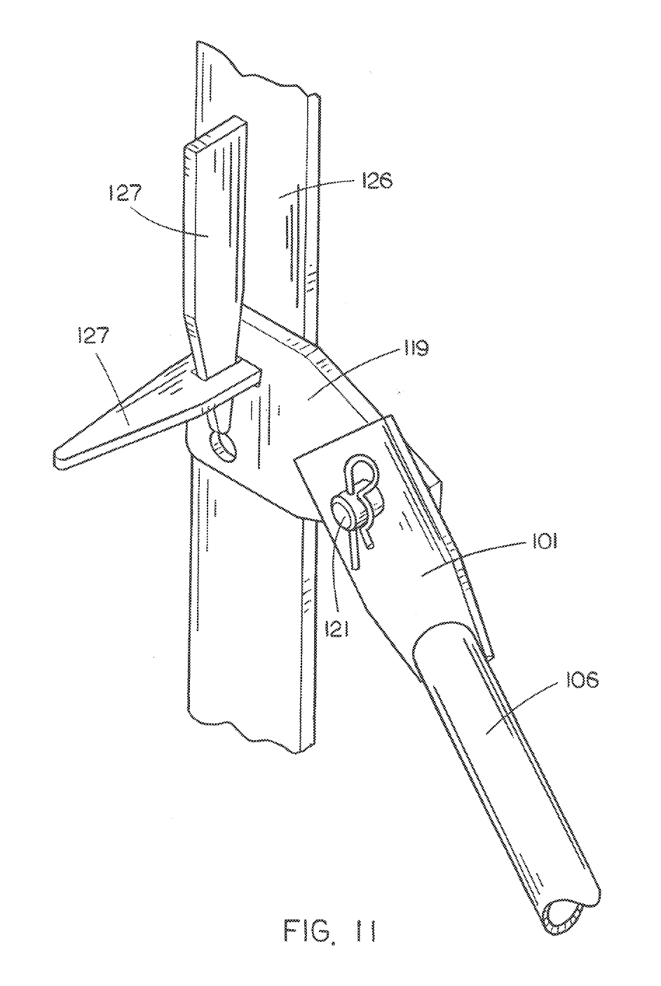

Referring to FIGS. 9-11, the adjustable wall brace 100 may further include a concrete form adapter 119. The concrete form adapter 119 may include a base plate 120 and a projection 121. The projection 121 may extend from the base plate 120 so as to engage a receiving aperture 122 of the plate 101. The projection 121 may be secured within the receiving aperture 122 by a cotter pin 123 or other locking mechanism. The concrete form adapter 119 may be allowed to rotate about the projection 121 so as to facilitate alignment of an adapter aperture 124 with the corresponding concrete form aperture 125 of a concrete form member 126. The concrete form adapter 119 may be coupled to the concrete form member 126 by disposing concrete form locking pins 127 through the adapter aperture 124 and the concrete form aperture 125. 128

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. An adjustable wall brace comprising:
an adjustment portion including a right-hand threaded portion and a left-hand threaded portion;
an extension portion including a threaded aperture configured to received at least one of the right-hand threaded portion and the left-hand threaded portion; and
a base portion including a threaded aperture configured to received at least one of the right-hand threaded portion and the left-hand threaded portion.

2. The adjustable wall brace of claim 1, wherein the adjustment portion further comprises:
a torque assist portion.

3. The adjustable wall brace of claim 1, wherein the adjustment portion further comprises:
one or more locking nuts.

4. The adjustable wall brace of claim 1, wherein the extension portion further comprises:
an extendable member; and
a receiving member configured to receive the extendable member.

5. The adjustable wall brace of claim 4, further comprising:
one or more locking mechanisms;
wherein the extendable member and the receiving member include one or more cooperating locking mechanism apertures configured to receive the one or more locking mechanisms.

6. The adjustable wall brace of claim 5, wherein the one or more locking mechanisms comprise:
one or more locking pins.

7. The adjustable wall brace of claim 5, wherein the one or more locking mechanisms comprise:
one or more spring actuated mechanisms internal to the extendable member and the receiving member.

8. The adjustable wall brace of claim 1, further comprising:
a wall-engaging portion.

9. The adjustable wall brace of claim 8, wherein the wall-engaging portion includes a substantially planar plate configured in a substantially vertical position when the adjustable wall brace is in an operational position.

10. The adjustable wall brace of claim 8, further comprising:
one or more concrete form adapters.

11. The adjustable wall brace of claim 10, wherein the one or more concrete form adapters comprise:
a base plate; and
a projection member.

12. The adjustable wall brace of claim 11, wherein the projection member is configured to be received by a receiving aperture of the wall-engaging portion.

13. The adjustable wall brace of claim 11, wherein the base plate comprises:
one or more concrete form locking pin receiving apertures.

14. The adjustable wall brace of claim 1, wherein the base portion further comprises:
a shaft portion; and
a hinged footplate operably coupled to the shaft portion.

15. The adjustable wall brace of claim 14, wherein the hinged foot plate comprises:
a u-shaped reinforcement member.

16. A method for manufacturing an adjustable wall brace comprising:
disposing an extension member within an extension receiving member;
receiving a first threaded portion of a dual-threaded adjustment mechanism within a threaded receiving aperture of at least one of the extension member and the extension receiving member; and
receiving a second threaded portion of the dual-threaded adjustment within a second threaded receiving aperture.

17. A method for bracing a wall comprising:
extending an extension portion of a wall brace;
locking the extension portion such that the wall brace is configured at a first length;
affixing a top end of the wall brace to a wall;
affixing a bottom end of the wall brace to a floor;
adjusting a dual-threaded adjustment mechanism such that the wall brace is configured at a second length.

18. The adjustable wall brace of claim 17, wherein the adjusting a dual-threaded adjustment mechanism further comprises:
rotating a first threaded portion of the dual-threaded adjustment mechanism within a threaded receiving aperture of the extension portion; and
rotating a second threaded portion of the dual-threaded adjustment mechanism within a second threaded receiving aperture.
